(19) United States
(12) Patent Application Publication
(10) Pub. No.: US 2015/0341375 A1
(43) Pub. Date: Nov. 26, 2015

(54) PRESENTING LOCATIONS OF USERS AND STATUS OF DEVICES

(71) Applicant: Operational Data Analytics LLC, Houston, TX (US)

(72) Inventors: Hal G. BAUER, Hawthorn Woods, IL (US); Norman T. GILSTER, Albuquerque, NM (US); Eugene E. HATHAWAY, Pearland, TX (US); Robert J. VILLENEUVE, Baytown, TX (US)

(21) Appl. No.: 14/547,629

(22) Filed: Nov. 19, 2014

Related U.S. Application Data
(60) Provisional application No. 62/002,018, filed on May 22, 2014.

(51) Int. Cl. H04L 29/06

(52) U.S. Cl. CPC H04L 63/1408; H04L 63/107

(57) ABSTRACT

A non-transitory computer-readable storage medium comprising instructions stored thereon. When executed by at least one processor, the instructions may be configured to cause a computing system to at least maintain at least a first location of a first access monitor and a second location of a second access monitor, receive at least a first notification of access to the first access monitor by a user and a second notification of access to the second access monitor by the user, determine a location of the user based on the maintained first location and second location and the received first notification and/or second notification, and present the determined location of the user.

### RELATED APPLICATION

This application claims the benefit of and priority to U.S. Provisional Application No. 62/002,018, filed May 22, 2014, which is incorporated herein by reference in its entirety.

### TECHNICAL FIELD

This description relates to electronic reporting systems.

### BACKGROUND

Security systems may include electronic devices that report information to a server. The server may generate and send images to a client, which may present the reported information.

### SUMMARY

A non-transitory computer-readable storage medium may comprise instructions stored thereon. When executed by at least one processor, the instructions may be configured to cause a computing system to at least maintain at least a first location of a first access monitor and a second location of a second access monitor, receive at least a first notification of access to the first access monitor by a user and a second notification of access to the second access monitor by the user, determine a location of the user based on the maintained first location and second location and the received first notification and/or second notification, and present the determined location of the user.

A non-transitory computer-readable storage medium may comprise instructions stored thereon. When executed by at least one processor, the instructions may be configured to cause a computing system to at least maintain locations and types of a plurality of access monitors, retrieve estimated lifetimes of the plurality of access monitors based on the types of the plurality of access monitors, determine when the plurality of access monitors are approaching an end of their estimated lifetimes, and indicate locations of access monitors that are approaching the end of their estimated lifetimes.

An electronic security system may comprise a plurality of access monitors configured to send, in response to access requests from any of a plurality of users, access notifications to a computing system, and the computing system. The computing system may be configured to maintain locations and types of the plurality of access monitors, retrieve estimated lifetimes of the plurality of access monitors based on the types of the plurality of access monitors, receive the access notifications from the plurality of access monitors, increment usage values associated with the plurality of access monitors in response to receiving the access notifications, determine when the plurality of access monitors are approaching an end of their estimated lifetimes, indicate locations of access monitors that are approaching the end of their estimated lifetimes, update locations associated with the users based on the maintained locations of the plurality of access monitors and the received access notifications, and present the updated locations.

The details of one or more implementations are set forth in the accompanying drawings and the description below. Other features will be apparent from the description and drawings, and from the claims.

### BRIEF DESCRIPTION OF THE DRAWINGS

FIG. 1 shows an electronic security system according to an example implementation.

FIG. 2 is a block diagram of a server included in the security system of FIG. 1 according to an example implementation.

FIG. 3 is a diagram of a security area included in the electronic security system of FIG. 1 according to an example implementation.

FIGS. 4A and 4B are screenshots showing reports according to an example implementation.

FIG. 5 is a screenshot showing information about users according to an example implementation.

FIG. 6 is a screenshot showing which users have moved to a safe area during an emergency situation according to an example implementation.

FIG. 7 is a screenshot showing information about access monitors included in the electronic security system of FIG. 1 according to an example implementation.

FIG. 8 is a screenshot showing information about systems included in the electronic security system of FIG. 1 according to an example implementation.

FIG. 9 is a flowchart showing a method according to an example implementation.

FIG. 10 is a flowchart showing a method according to another example implementation.

Like numbers refer to like elements.

### DETAILED DESCRIPTION

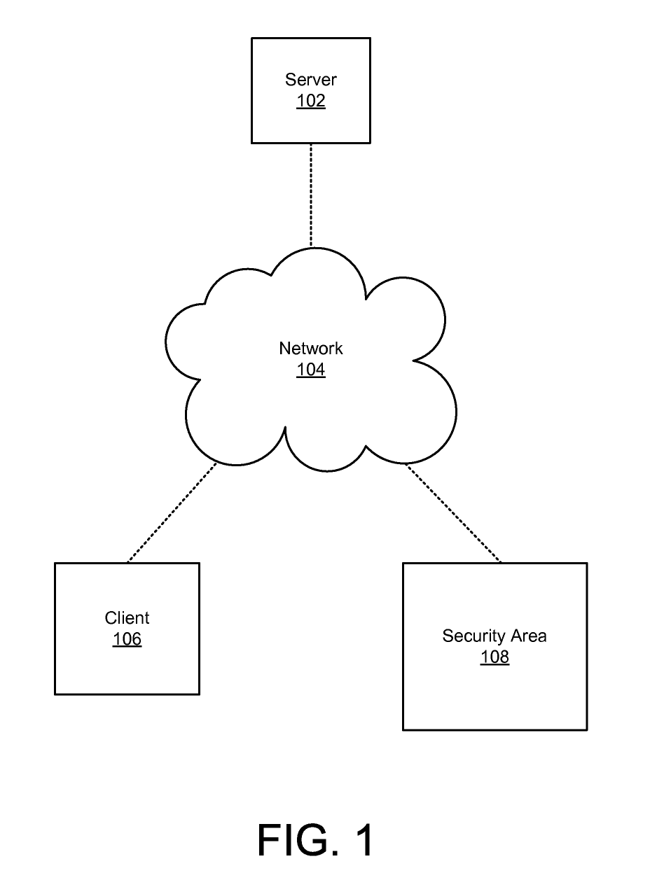

FIG. 1 shows an electronic security system according to an example implementation. The electronic security system may include, for example, an Access Control and Alarm Management System (ACAMS). The electronic security system may include a server 102 monitoring a security area 108 by receiving information from the security area via a network 104, and providing information about the security area 108 to a client 106 via the network 104.

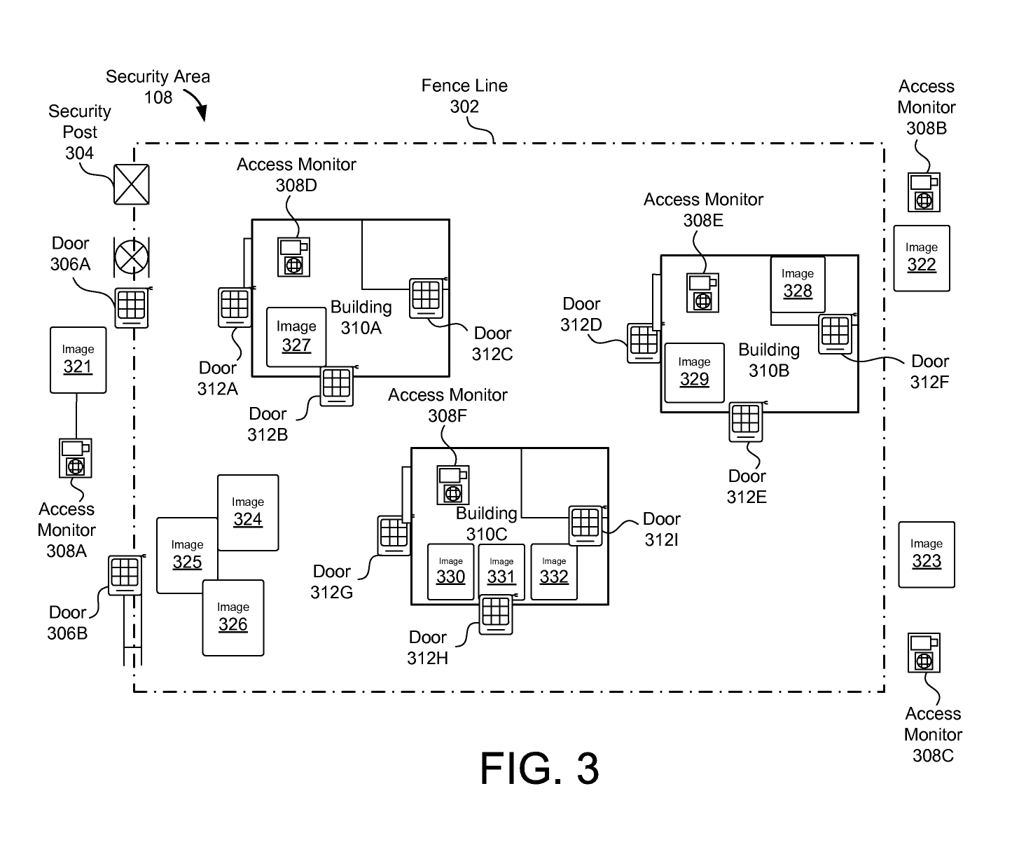

The security area 108 (an example of which is shown in FIG. 3) may include a location such as a building, and may include access monitors. The access monitors, which may include electronic card readers that scan or otherwise read electronic cards carried by employees and/or users associated with accounts, or may detect when employees and/or users associated with accounts, which may be carrying electronic devices, come within a certain distance of the access monitors, may send notifications to the server 102 indicating when the employees and/or users enter and/or exit locations within the security area 108. Users may be associated with accounts, and may include persons such as employees, security personnel, persons authorized to enter an area, robots, machines, and/or vehicles. The server 102 may maintain locations of the access monitors. The server 102 may also maintain locations of the users associated with the accounts, and may determine and/or update the locations of the users associated with the accounts based on the received notifications. The server 102 may generate and send images to the client 106 for the client 106 to present to a user of the server 102, who may be an administrator or security officer of the security area 108, one or more images indicating where in the security area the users associated with the accounts are located.

The server 102 may also maintain types of the access monitors, such as their manufacturing models. The server 102 may retrieve and/or maintain estimated lifetimes of the access monitors and use of the access monitors. The server 102 may determine when the access monitors are reaching or approaching an end of their estimated lifetimes and should be replaced, and may provide an indication to the client 106 that the access monitors are reaching or approaching the end of their lifetimes so that the administrator or security officer may replace the access monitors.

The client 106 may include any computing device capable of receiving signals representing images from the server 102, generating and presenting the images to a user or administrator, receiving input from the user or administrator, and sending the input to the server 102. The client 106 may include, for example, a desktop computer, a laptop or notebook computer, a tablet computer, a personal digital assistant (PDA), or a smartphone or mobile phone with a display, as non-limiting examples.

The network 104 may include a system that allows communication between computing devices, such as between the access monitors and the server 102 and between the server 102 and the client 106. The network 104 may include, for example, a Local Area Network (LAN), a wireless LAN (WLAN), and/or the Internet.

The security area 108 may include an area monitored by the server 102. The security area 108 may include one or more buildings, and may include one or more access monitors that send messages, signals, and/or reports to the server 102 indicating when personnel and/or users associated with accounts have entered and/or exited specified locations.

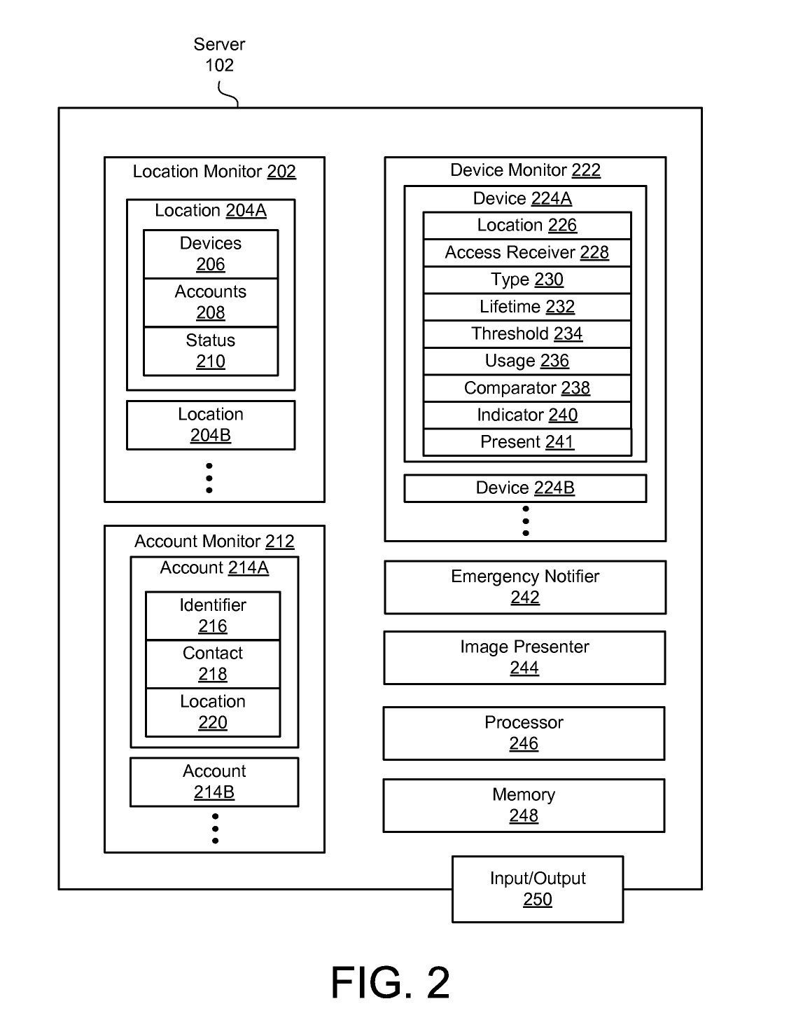

FIG. 2 is a block diagram of the server 102 included in the security system of FIG. 1 according to an example implementation. The server 102 may perform any or all of the functions or techniques described herein.

The server 102 may include a location monitor 202. The location monitor 202 may maintain information with regard to any number, such as one or more, of locations 204A, 204B in the security area 108 (not shown in FIG. 2). Locations may be organized into device/reader/door groups, with locations being based on a nearest door(s) and/or access monitor(s), such as a building.

The information maintained by the location monitor 202 with respect to each location 204A, 204B may include devices 206 in the location, users associated with accounts 208 in the location, and/or a status 210 of the location. The location monitor 202 may generate reports of, for example, how often a user comes into a particular (such as his or her) office, who came into the office, the times of attendance of each person, how many hours and/or minutes each person was in the office, and/or, with respect to a building, how many unique persons came into the building. The location monitor 202 may also store date including what alarms are located in and/or associated with each location 204A, 204B, and/or whether the devices are functional or have failed.

The devices 206 may include one or more access monitors in the location. The location monitor 202 may store and/or maintain, for the devices 206, an identifier, which may include an Institute for Electrical and Electronic Engineers (IEEE) Medium Access Control (MAC) address, a manufacturer-assigned serial number, and/or an identifier assigned by the server 102, and/or a type of the device 206.

The accounts 208 may identify users associated with accounts located in the location 204A, 204B. The accounts 208 associated with users in the location 204A, 204B may identify employees, authorized personnel, and/or any persons or entities with personal electronic devices that communicate with the devices 206 and/or access monitors. The accounts 208 may include and/or store, in addition to users are in the location, a log of entries and exits by the users associated with the accounts into and out of the location 204A, 204B, and/or a log of users associated with accounts that were in the location 204A, 204B within specified time periods along with the durations of time in the location and/or times of entry and exit.

The status 210 may indicate, for each location 204A, 204B, a safety or destination status. For example, the status 210 may indicate that the location 204A, 204B is an emergency zone, such as weather the location 204A, 204B is subject to a fire, an oil leak, chemical risk, a gas leak, or that the location 204A, 204B is a safe zone, as non-limiting examples.

The server 102 may include an account monitor 212. The account monitor 212 may maintain, as well as update and/or determine, information associated with any number of, such as one or more, users associated with accounts 214A, 214B. The accounts 214A, 214B may correspond to the accounts 208 maintained with respect to each location 204A, and may include users including persons such as employees and/or personnel authorized to enter the security area 108.

For each account 214A, 214B, the account monitor 212 may maintain an identifier 216. The identifier 216 may be a unique value associated with the account 214A. The identifier 216 may include a name, a social security number, or an identifier assigned by the employer or security system to the person associated with the account. The identifier 216 may additionally, or alternatively, include an identifier of an electronic device carried by the user associated with the account that communicates with the access monitors.

For each account 214A, 214B and associated user, the account monitor 212 may also maintain and/or store contact information 218. The contact information 218 may include, for example, a location of employment (such as address and/or room number), a residential address, a work telephone number, a home telephone number, a mobile telephone number, a work email address, and/or a personal email address, as non-limiting examples.

For each user associated with an account 214A, 214B, the account monitor 212 may also store one or more locations 220. The locations 220 may correspond to the locations 204A, 204B maintained by the location monitor 202. The location may be based on the user's last access at an access monitor within a location. The account monitor 212 may maintain, for each user associated with an account 214A, 214B, a present location, a log of locations entered into and/or exited and the duration of time in the locations, and/or a log of log of entries and exits into and from locations.

The server 102 may also include a device monitor 222. The device monitor 222 may maintain, determine, and/or update information associated with each of the access monitors in the security area 108.

The device monitor 222 may maintain information associated with multiple, or one or more, devices 224A, 224B, which may correspond to access monitors or may include access monitors and other types of devices. For each device 224A, 224B, the device monitor 222 may maintain a location 226. The location may include a room identifier and/or number, a door identifier and/or number, coordinates such as x- and y-coordinate with respect to a point in the security area 108 and a floor number, and/or Global Positioning System (GPS) coordinates, as examples. The location 226 may correspond to a location 204A, 204B, 220 maintained by either or both of the location monitor 202 and account monitor 212. The location may also include information such as what architectural drawing the device 224A, 224B and/or associated drawing appears in, what power supply the device 224A, 224B draws power from, what vendor installed the device 224A, 224B, what vendor services the device 224A, 224B, and/or what wires are coupled to the device 224A, 224B.

The device monitor 222 may also include an access receiver 228 for each device 224A, 224B. The access receiver 228 may receive signals and/or messages from access monitors indicating that a user, such as a person, device or other object with an identifier associated with an account, has passed through and/or accessed an access monitor. The signal and/or message that the access receiver 228 receives from an access monitor may include an identifier of the device 224A, 224B, and an identifier of the account 214A, 214B. The signal and/or message may include an identifier of the location 204A, 204B associated with the device 224A, 224B, or the server 102 may determine the location 204A, 204B based on the identifier of the device 224A, 224B.

In response to the access receiver 228 receiving a signal and/or message from an access monitor indicating access or passage by the user associated with the account to or by the device 224A, 224B, the server 102 may update information maintained by the associated location 204A, 204B, account 214A, 214B, and/or device 224A, 224B. The server 102 may, for example, update the location 204A, 204B to indicate that an indicated user associated with an account 214A, 214B is in, or is no longer in, the location 204A, 204B, may update the indicated account 214A, 214B to change the location 220, and/or may update a usage 236 (described below) of the device 224A, 224B to indicate the access.

The device monitor 222 may maintain a type 230 for each device 224A, 224B. The type 230 may include, for example, a model number of the device 224A, 224B, a description of the device 224A, 224B such as “card swipe reader” or “wireless proximity detector,” a year or manufacture or purchase of the device 224A, 224B, or a manufacturer of the device 224A, 224B.

The device monitor 222 may maintain an estimated lifetime 232 for each device 224A, 224B. The estimated lifetime 232 may be based on the type 230 of the device 224A, 224B. The estimated lifetime 232 may include a time duration, such as years, months, weeks, days, and/or hours, and/or may include a number of accesses to the device, such as the number of times access cards are swiped through the device. The time duration may be based on a time since manufacture, a time since first use, or a total time of use (not including downtime) of the device. The server 102 may maintain, and/or access a database maintaining, estimated lifetimes for multiple types of devices, including access monitors included in the security area 108 and/or maintained by the security system. The estimated lifetimes for each device type may be retrieved from an external database, may be loaded onto the server 102, or may be entered into the server 102 individually by an administrator of the security system.

The device monitor 222 may maintain and/or store a threshold 234 for each of the devices 224A, 224B. The threshold 234 may be a point at which the device 224A, 224B should be replaced. The threshold 234 may be a specified fraction or percentage of the estimated lifetime 232, or a point at which a specified remainder of the estimated lifetime 232 is remaining. For example, the threshold may be 80% or 90% of the estimated lifetime 232, or may be the estimated lifetime minus a remainder such as month, three months, or a number of remaining swipes.

The device monitor 222 may maintain a usage 236 of each of the devices 224A, 224B. The maintained usage 236 may be a time duration, may be a time since manufacture, a time since first use, or a total time of use (not including downtime) of the device 224A, 224B, or may be a number of accesses or swipes to the device 224A, 224B.

The device monitor 222 may include a comparator 238. The device monitor 222 may include a comparator for each device 224A, 224B, or a single comparator that performed comparisons of values for each device 224A, 224B. The comparator 238 may compare the usage 236 associated with and/or stored for each device 224A, 224B to the threshold 234 associated with the device 224A, 224B. The comparator 238 may compare the usage 236 to the threshold 234 periodically, and/or in response to events such as the access receiver 228 receiving a signal or message indicating that the device 224A, 224B has been accessed. If the usage 236 meets or exceeds the threshold 234, the comparator 238 may send a signal to an indicator 240 indicating that the usage 236 associated with the device 224A, 224B has met or exceeded the threshold 234 associated with the device 224A, 224B.

The device monitor 222 may include an indicator 240. The device monitor 222 may include an indicator 240 for each device 224A, 224B, or a single indicator 240 that provides indications based on comparisons for each device 224A, 224B. The indicator 240 may generate notifications of when a device 224A, 224B has met or exceeded the threshold 234 associated with the device 224A, 224B. The indicator 240 may, for example, generate service tickets and/or messages instructing maintenance personnel to replace the device 224A, 224B that has met or exceeded the threshold 234.

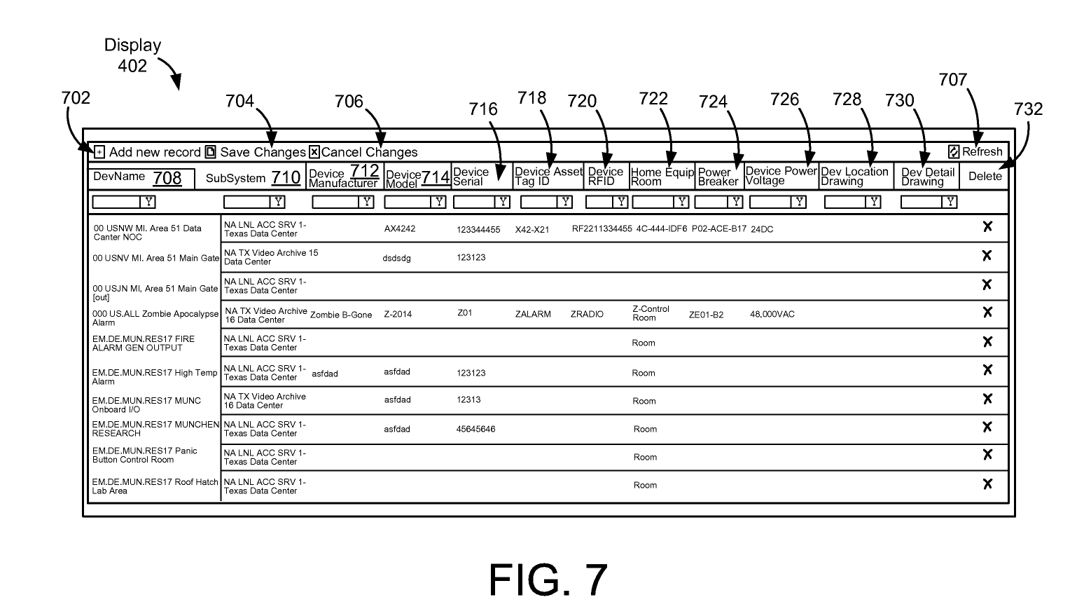

The device monitor 222 may also include a present flag 241 for each device 224A, 224B. The present flag 241 may indicate whether the device 224A, 224B is present in the security area 108. An administrator of the security system may remove and/or delete a device 224A, 224B from the security system. Rather than deleting the device 224A, 224B from the database and/or memory 248 (described below), the device monitor 222 may change the present flag 241 of the removed and/or deleted device to indicate that the device 224A, 224B has been deleted and/or is no longer present in the security system. The server 102 may thereafter include the removed and/or deleted device 224A, 224B in reports, and may indicate that the device 224A, 224B has been removed and/or deleted. Reports, such as the reports shown in FIGS. 7 and/or 8, may indicate whether the devices 224A, 224B are present in the security system or have been removed and/or deleted.

The server 102 may include an emergency notifier 242. The emergency notifier 242 may prompt the server 102 to perform actions in response to an emergency, such as a fire, a gas leak, an explosion, or an oil leak, as non-limiting examples. The emergency notifier 242 may receive an emergency notification from an entity outside the server 102 such as an entity in the security area 108, via the network 104. The emergency notification may indicate one or more locations in the security area 108 which are considered dangerous, and in which users and/or personnel should not be located and/or from which users and/or personnel should exit. The emergency notifier 242 may cause the server 102 to generate reports in response to an emergency, such as which users and/or personnel are in a dangerous area, which users and/or personnel are out of the dangerous area, and/or which users and/or personnel are in a safe area.

The emergency notifier 242 may also support alert services, such as “Google Alerts”™. The emergency notifier 242 may receive an emergency notification from the alert service. The emergency notifier 242 may perform actions in response to receiving an emergency notification from the alert service, including identifying which users and/or personnel are in or out of a dangerous area and/or which users and/or personnel are in a safe area.

The server 102 may include an image presenter 244. The image presenter 244 may generate images for display by the client 106. The image presenter 244 may, for example, generate images for a display on a web browser running on the client 106. The image presenter may support a “resize to device” presentation, formatting the size of the images to the display of the client 106, thereby supporting displays for desktop computers, laptop or notebook computers, tablet computers, PDAs, and/or smartphones or mobile phones with displays, as non-limiting examples. The images may include, for example, alarm messages (which may be considered emergency notifications) received along with dates, times, and locations, access granted transactions along with dates, times, names or other identifiers of personnel and/or users to whom access was granted, account or access card number, and location at which access was granted, identification information of personnel and/or users associated with accounts, reports of users and/or personnel in a dangerous area(s), out of the dangerous area, and/or in a safe area, and/or reports of devices and/or access monitors. The image presenter 244 may send the images to the client 106 via the network 104.

The server 102 may include one or more processors 246. The one or more processors 246 may execute instructions, such as instructions stored on one or more memory devices 248, and perform functions and processes, such as the functions and processes described herein.

The server 102 may include one or more memory devices 248. The one or more memory devices 248 may include at least one non-transitory computer-readable storage medium comprising instructions stored thereon that, when executed by at least one processor, such as the at least one processor 246, are configured to cause a computing system, such as the server 102, to perform any combination of the functions and processes described herein.

The server 102 may include an input/output module 250. The input/output module 250 may include one device that performs both input and output functions, may include one device that performs input functions and one device that performs output functions, or may include more that two devices that perform a combination of input and output functions. The input/output module 250 may receive and send information from and two other computing devices, such as the client 106 and devices in the security area 108, via the network 104.

FIG. 3 is a diagram of a security area included 108 in the electronic security system of FIG. 1 according to an example implementation. FIG. 3 may be a schematic of the security area 108, and/or may be a screenshot of an image generated by the server 102 (not shown in FIG. 3) and displayed on the client 106 (not shown in FIG. 3) to show a layout of the security area 108 and locations of users associated with accounts.

In this example, the security area 108 may include a perimeter defined by a fence line 302. The fence line 302 may include an actual fence, walls of a campus, or imaginary lines defining areas inside and outside the fence line 302. The security area 108 may also include a security post 304. The security post 304 may include a security guard, a camera, or other personnel or device for monitoring users and/or activities within the security area 108.

In an example embodiment, the security area 108 may include doors 306A, 306B along the fence line 302. The fence line 302 may limit access to traveling through either of the doors 306A, 306B.

The security area 108 may include access monitors 308A, 308B, 308C outside the fence line 302. The access monitors 308A, 308B, 308C (as well as access monitors 308D through 308H inside the fence line) may include electronic devices that monitor personnel and/or users (e.g., persons, or devices, vehicles or other objects associated with an account) passing into or through predefined areas. In this manner, the access monitors 308 may monitor or keep track of a user and/or an account (e.g., keep track or monitor a user/personnel associated with an account, a device such as an electronic access card for an account, a vehicle which may include a wireless access card that may be detected by access monitor 308, or other object associated with an account that may be detected or monitored). The access monitors 308A-308H may, for example, include electronic card readers that detect when personnel/accounts swipe an electronic card through the access monitor 308A-308H and report the swipe to the server 102 (not shown in FIG. 3), electronic devices that wirelessly detect the proximity of electronic devices carried by personnel/accounts and report the entry of movement to the server 102, or biometric readers, such as devices that detect and/or interpret fingerprints or irises.

Access monitor 308A may monitor entries into, and exits from, the area bounded by the fence line 302, and send reports, signals, and/or messages indicating entries and/or exits to the server 102. The server 102 may determine which users associated with accounts are inside the fence line 302 based on the reports received from the access monitor 308A.

The access monitors 308B, 308C may be located near a “safe area” to which personnel and/or users associated with accounts should muster in the event of an emergency. The personnel and/or users associated with accounts may have been previously instructed to muster to the safe area in the event of an emergency, or may be instructed to muster to the safe area during an emergency, such as via a loudspeaker. The access monitors 308B, 308C may send reports, signals, and/or messages indicating arrival at the safe zone by the personnel and/or users associated with accounts to the server 102. The server 102 may determine which users associated with accounts and/or personnel are at the safe zone based on the reports received from the access monitor 308A.

The example security area 108 includes a plurality of images 321, 322, 323, 234, 325, 326, 327, 328, 329, 330, 331, 332. The images 321-332 may represent personnel and/or users associated with accounts, and may include photographs of the persons associated with the accounts. The locations of the images 321-332 may indicate the locations of persons associated with the accounts, as determined by the server 102. A security administrator may look at the diagram, including the images 321-332, and quickly determine which users are in a mustered area and which users are in an endangered area.

The security area 108 may include multiple buildings 310A, 310B, 310C inside the fence line 302. The buildings 310A, 310B, 310C, and/or the area or volume inside the walls of the buildings, may be considered “areas” which may be considered either safe or endangered during an emergency. Each building 310A, 310B, 310C may have, and/or be associated with, a limited number of doors 312A, 312B, 312C, 312D, 312E, 312F, 312G, 312H, 3121 allowing entry and exit from the associated building 310A, 310B, 310C. Each building 310A, 310B, 310C may have, and/or be associated with, one or more access monitors 308D, 308E, 308F. The access monitors 308D, 308E, 308F may monitor entry into, and exit from, their associated buildings 310A, 310B, 310C, and may send reports, signals, and/or messages to the server 102 indicating users associated with accounts that enter or exit their associated buildings 310A, 310B, 310C.

In the example scenario shown in FIG. 3, the users and/or personnel associated with the images 321-332 may be assigned into groups. A first group of users inside the facility and/or inside the fence line 302 but not inside any of the buildings 310A, 310B, 310C may include users and/or accounts associated with images 324, 325, 326. A second group of users who has accessed the access monitor 308D, who has entered the building 310A, and/or who the location monitor 202 considers inside the building 310A may include the user and/or account associated with image 327. A third group of users who has accessed the access monitor 308E, who has entered the building 310B, and/or who the location monitor 202 considers inside the building 310B may include the users and/or accounts associated with images 328, 329. A fourth group of users who have accessed the access monitor 308F, who have entered the building 310C, and/or who the location monitor 202 considers inside the building 310C, may include the users and/or accounts associated with images 330, 331, 332. A fourth group of users who have accessed any of the access monitors 308A, 308B, 308C outside the fence line 302, and/or who the location monitor 202 considers outside the fence line 302 and/or facility may include the users and/or accounts associated with images 321, 322, 323.

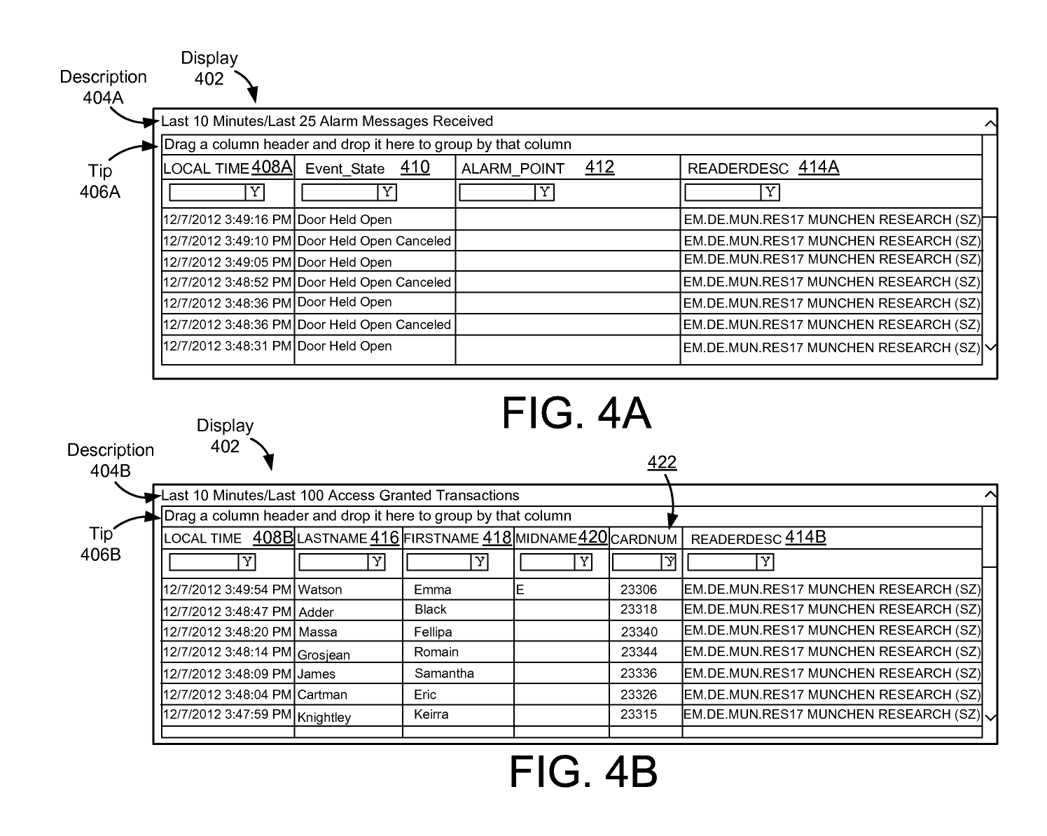

FIGS. 4A and 4B are screenshots showing reports according to an example implementation. The reports may be based on real-time data received by the server 102 from the access monitors 308A-308F and dynamic filtering and grouping performed by the server 102.

In the example shown in FIG. 4A, a display 402 may be presented to a user of the server 102 or administrator by the client 106. The display 402 may present a description 404A of the report. In this example, the report indicates alarm messages that were recently received, such as the last twenty-five alarm messages received in the last ten minutes (not all twenty-five alarm messages are shown in FIG. 4A for the sake of brevity). The display 402 may present a tip 406A for selecting filtering options.

In the example shown in FIG. 4A, the display 402 includes columns showing a local time 408A of the alarm messages, an event state 410 which may indicate an event reported by the alarm message (such as the door being held open or a door held open status being canceled), an alarm point 412 indicating a location 226 from which the alarm message originated, and a reader description 414A providing a description of the device or access monitor 308A-308F which sent the alarm message to the server 102. More or fewer columns providing information about the alarm messages may be included in the display 402.

In the example shown in FIG. 4B, the display 402 may also be presented to a user of the server 102 or administrator by the client 106. In this example, the description 404B indicates that the display is presenting a report of recently granted access transactions to the access monitors 308A-308F. The report may include the last one hundred access granted transactions, and/or the access granted transactions within the last ten minutes. For the sake of brevity, not all of the transactions are shown in FIG. 4B.

The display 402 may present columns including a local time 408B of the transaction, a last name 416 of the person or user associated with an account to whom access was granted, a first name 418 of the person or user associated with the account to whom access was granted, a middle name 420 of the person or user associated with the account to whom access was granted, a card number 422 of the person or user associated with the account to whom access was granted, and a reader description 414B providing a description of the access monitor 308A-308F which granted the access and sent the message, report, and/or signal to the server 102.

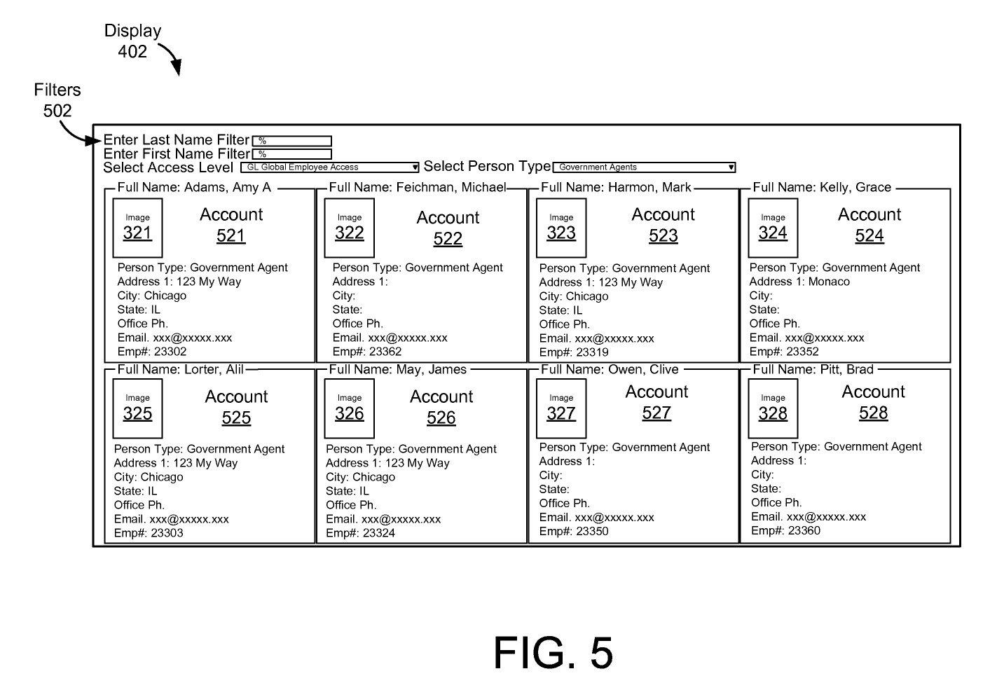

FIG. 5 is a screenshot showing information about accounts, and/or users associated with accounts, according to an example implementation. The display 402 may present a “card view” which includes information about users and/or accounts similar to what would be included in a business card. In this example, the display 402 presented by the client 106 may present filters 502 for a user or administrator to select. The filters 502 may include, for example, a last name filter to filter users and/or accounts or personnel by last name, a first name filter to filter users associated with accounts by first name, an access type filter to filter users associated with accounts by the access level granted to them, and/or a person type filter to filter users associated with accounts by person or employee type.

For each of the users and/or accounts that met the filter criteria, the display may present the users and/or associated accounts 521, 522, 523, 524, 524, 525, 526, 527, 528. The accounts 521-528 may include images 321-328 of the persons or users associated with accounts that correspond to the images 321-328 shown in FIG. 3, and may include names and photographs of the personnel, users associated with accounts, and/or employees, and may include information about the users associated with the accounts, such as person or employee type and contact information such as address, city, state, office telephone number, and/or email address, and/or an employee number.

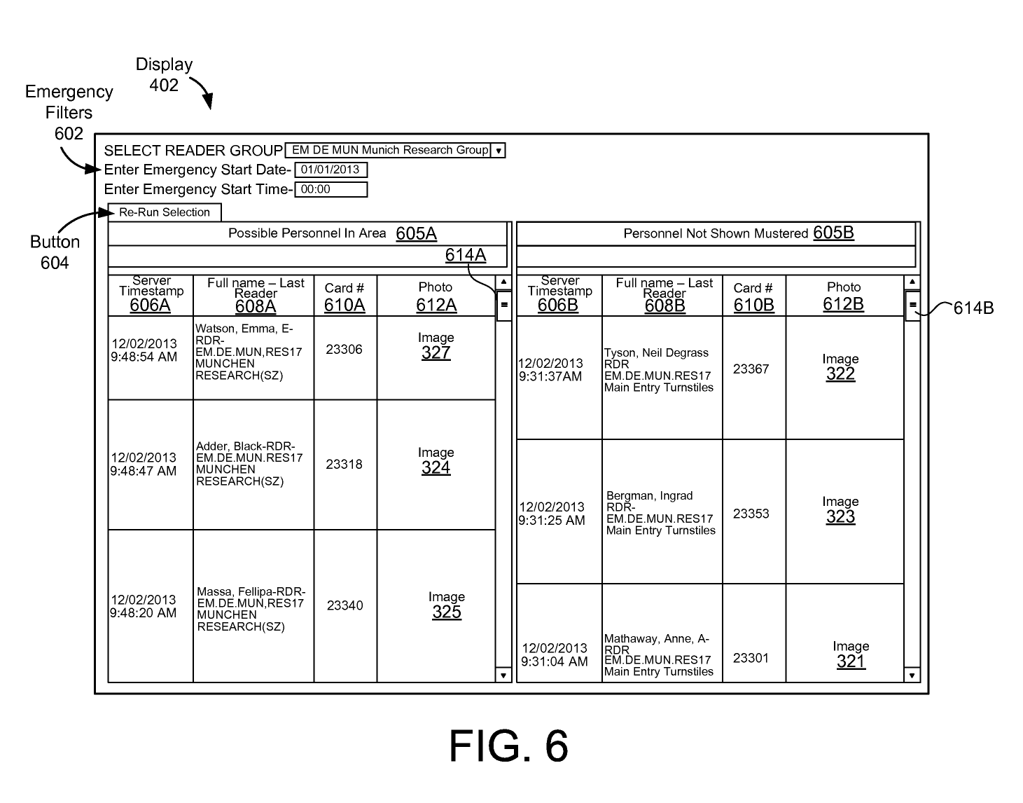

FIG. 6 is a screenshot showing which users have moved to a safe area during an emergency situation according to an example implementation. The information shown in the display 402 may be shown when an emergency situation has been reported. This information may help security personnel to evacuate persons from dangerous areas to safe areas.

In an example implementation, the display 402 may present emergency filters 602 to a user of the server 102 or administrator. The emergency filters 602 may include a reader group, which may include a subset of users associated with accounts, and/or users associated with accounts who have recently entered a specified area, such as the security area 108. The filters 602 may also include a start date and time of the emergency. The display 402 may also include a button 604 that the user of the server 102 or administrator may press or click on to prompt a redetermination and display of users in dangerous and safe areas.

The display 402 may present a first section 605A showing users in a safe area and/or who have “mustered” to a specified location, and a second section 605B showing users in a dangerous area and/or who have not mustered to the specified location. For each user associated in either section 605A, 605B, the display 402 may present a server timestamp 606A, 606B indicating the most recent message, signal, or report received from an access monitor 308A-308F indicating the user's location, the user's name 608A, 608B, the user's card number 610A, 610B or electronic device number, and a photo 612A, 612B with the image 327, 324, 325, 322, 323, 321 associated with the user. In this example, the users associated with images 327, 324, 325 (and others not shown in FIG. 6 for the sake of brevity) may be considered in a safe area and/or mustered, and the users associated with images 322, 323, 321 (and others not shown in FIG. 6 for the sake of brevity) may be considered in the dangerous area and/or mustered.

FIG. 7 is a screenshot showing information about access monitors included in the electronic security system of FIG. 1 according to an example implementation. The information may be presented by the display 402. An interface in the display 402 may include an add new record button 702 allowing a user or administrator to add a new record associated with a device 224A, 224B for which information is maintained by the device monitor 222 (not shown in FIG. 7), a save changes button 704 allowing the user of the server 102 and/or administrator to save changes made to records (such as adding a new record for a device or access monitor), a cancel changes button 706 allowing a user of the server 102 and/or administrator to cancel changes made to the records, and/or a refresh button 707 allowing the user of the server 102 and/or administrator to request the display 402 be refreshed to show a most recent listing and/or status of devices.

The display 402 may present columns providing information about the devices 224A, 224B. The columns may include a device name column 708, a device subsystem column 710, a device manufacturer column 712, and/or a device model column 714, which may include information based on the type 230 stored in association with the device 224A, 224B. The columns may also include a device serial number column 716, a device asset tag ID column 718, and/or a device RFID column, which may include information stored in association with the device 224A, 224B. The columns may also include a home equipment room column 722, a power breaker column 724, a device power voltage column 726, a device location drawing column, and/or a device detail drawing column 730, which may be stored in association with the location 226 of the device 224A, 224B. Some or all of the information displayed in the columns 708, 710, 712, 714, 716, 718, 720, 722, 724, 726, 728, 730 may have been retrieved by the server 102 from a foreign host.

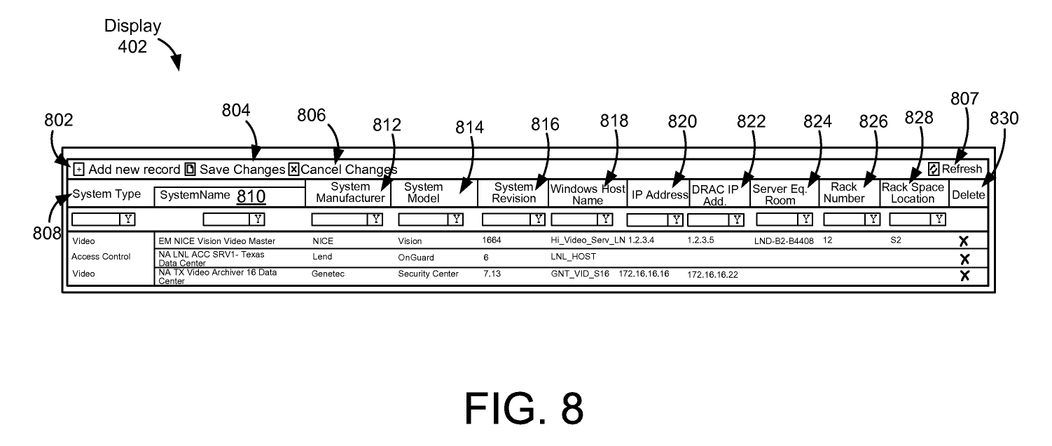

FIG. 8 is a screenshot showing information about systems included in the electronic security system of FIG. 1 according to an example implementation. The information may be presented by the display 402. An interface in the display 402 may include an add new record button 802 allowing a user of the server 102 or administrator to add a new record associated with a device 224A, 224B for which information is maintained by the device monitor 222 (not shown in FIG. 8), a save changes button 804 allowing the user of the server 102 or administrator to save changes made to records (such as adding a new record for a device or access monitor), a cancel changes button 806 allowing a user of the server 102 or administrator to cancel changes made to the records, and/or a refresh button 807 allowing the user of the server 102 or administrator to request the display 402 be refreshed to show a most recent listing and/or status of devices.

The display 402 may present columns providing information about systems, of which the devices 224A, 224B for which the presentation shown in FIG. 7 provided information. The columns may include a system type column 808 describing a type of the system, a system name column 810 listing a name of the system, a system manufacturer column 812 listing a manufacturer of the system, a system model column 814 listing a model of the system, a system revision column 816 listing a revision number for the system, a host name column 818 listing a host name of the system, an IP address column listing an Internet Protocol (IP) address of the system, a second IP address column 822 listing a remote access controller IP address of the system, a server room column 824 listing a server room of the system, a rack number column 826 listing a rack number of the system, a rack space location column 828 listing a location of the rack identified in the rack number column 826, and a delete column 830 including buttons allowing the user or administrator to delete systems from the database.

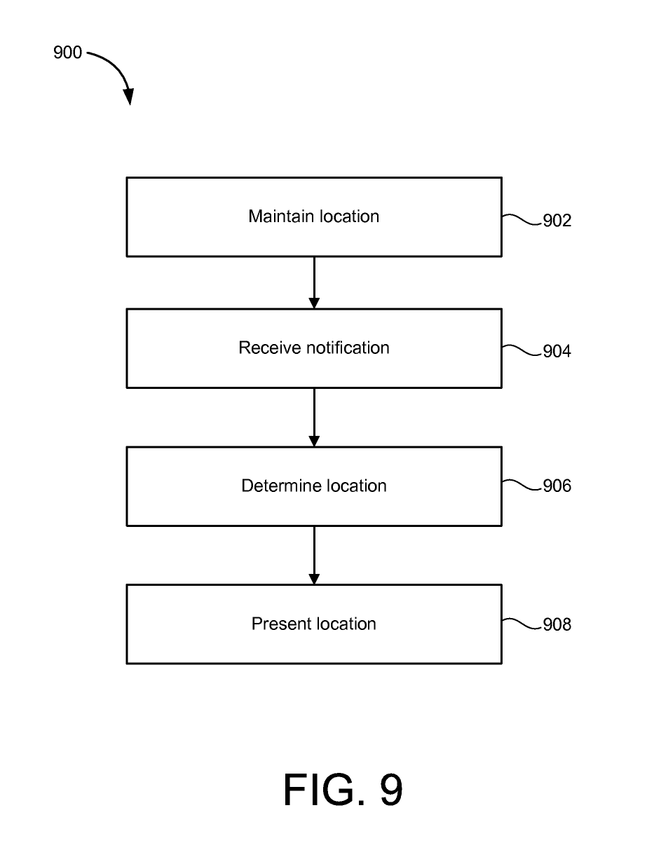

FIG. 9 is a flowchart showing a method 900 according to an example implementation. According to this example, the method 900 may include maintaining at least a first location of a first access monitor and a second location of a second access monitor (902). The method 900 may also include receiving at least a first notification of access to the first access monitor by a user and a second notification of access to the second access monitor by the user (904). The method 900 may also include determining a location of the user based on the maintained first location and second location and the received first notification and/or second notification (906). The method 900 may also include presenting the determined location of the user (908).

According to an example implementation, the second notification may be more recent than the first notification, and the determining the location of the user (906) may include determining the location of the user based on the maintained second location and the second notification.

According to an example implementation, the second access monitor may be associated with a building, and the determining the location of the user (906) may include determining whether the user is inside the building based on the second notification of access by the user to the second access monitor associated with the building and whether the user was inside the building before the second notification.

According to an example implementation, the presenting the location of the user (908) may include presenting the location of the user via a web browser.

According to an example implementation, the presenting the location of the user (908) may be performed in response to an emergency notification, the presenting the location of the user including indicating whether the user is in an emergency area.

According to an example implementation, the user may be a first user; and the method 900 may further include receiving a third notification of access to the first access monitor by a second user, determining a location of the second user based on the maintained first location and second location and the received third notification, and presenting the determined location of the first user and the determined location of the second user.

According to an example implementation, the method 900 may further include receiving additional notifications of access to the first access monitor and the second access monitor by additional users and presenting a number of users in the first location in response to an emergency notification, the emergency notification being associated with the first location.

According to an example implementation, the presenting the number of users may include presenting the number of users in the first location and images associated with the users in the first location in response to the emergency notification.

According to an example implementation, the method 900 may further include maintaining a status of the first access monitor and a status of the second access monitor. The presenting the determined location (908) may include presenting the determined location of the user, the status of the first access monitor, and the status of the second access monitor.

According to an example implementation, the method 900 may further include maintaining data associated with a deleted location.

According to an example implementation, the presenting the location of the user (908) may include determining a presentation size for a mobile device.

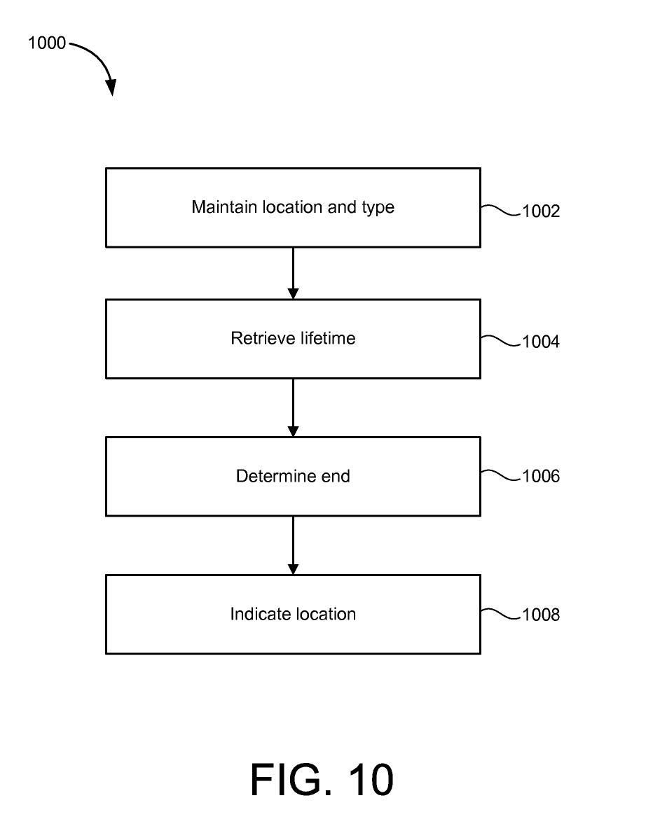

FIG. 10 is a flowchart showing a method 1000 according to another example implementation. According to this example, the method 1000 may include maintaining locations and types of a plurality of access monitors (1002). The method 1000 may also include retrieving estimated lifetimes of the plurality of access monitors based on the types of the plurality of access monitors (1004). The method 1000 may also include determining when the plurality of access monitors are approaching an end of their estimated lifetimes (1006). The method 1000 may also include indicating locations of access monitors that are approaching the end of their estimated lifetimes (1008).

According to an example implementation, the method 1000 may further include receive a threshold from an administrator. The determining (1006) may include determining when the plurality of access monitors are approaching the end of their estimated lifetimes based in part on the received threshold.

According to an example implementation, the estimated lifetimes may include time durations, and the determining (1006) may include comparing an age of the access monitor to the time duration.

According to an example implementation, the estimated lifetimes may include time durations, and the determining (1006) may include comparing a time of first use of the access monitor to the time duration.

According to an example implementation, the estimated lifetimes may include lifetime accesses to the access monitors, and the determining (1006) may include maintaining a number of accesses to the access monitors and comparing the number of accesses to the access monitor to the lifetime accesses.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the embodiments of the invention.

What is claimed is:

1. A non-transitory computer-readable storage medium comprising instructions stored thereon that, when executed by at least one processor, are configured to cause a computing system to at least:
maintain at least a first location of a first access monitor and a second location of a second access monitor;
receive at least a first notification of access to the first access monitor by a user and a second notification of access to the second access monitor by the user;
determine a location of the user based on the maintained first location and second location and the received first notification and/or second notification; and
present the determined location of the user.

2. The non-transitory computer-readable storage medium of claim 1, wherein:
the second notification was more recent than the first notification; and
the determining the location of the user includes determining the location of the user based on the maintained second location and the second notification.

3. The non-transitory computer-readable storage medium of claim 2, wherein:
the second access monitor is associated with a building; and
the determining the location of the user includes determining whether the user is inside the building based on:
the second notification of access by the user to the second access monitor associated with the building; and
whether the user was inside the building before the second notification.

4. The non-transitory computer-readable storage medium of claim 1, wherein the instructions are configured to cause the computing system to present the location of the user via a web browser.

5. The non-transitory computer-readable storage medium of claim 1, wherein the instructions are configured to cause the computing system to present the location of the user in response to an emergency notification, the presenting the location of the user including indicating whether the user is in an emergency area.

6. The non-transitory computer-readable storage medium of claim 1, wherein:
the user is a first user; and
the instructions are further configured to cause the computing system to:
receive a third notification of access to the first access monitor by a second user;
determine a location of the second user based on the maintained first location and second location and the received third notification; and
present the determined location of the first user and the determined location of the second user.

7. The non-transitory computer-readable storage medium of claim 1, wherein the instructions are further configured to cause the computing system to:
receive additional notifications of access to the first access monitor and the second access monitor by additional users; and
present a number of users in the first location in response to an emergency notification, the emergency notification being associated with the first location.

8. The non-transitory computer-readable storage medium of claim 7, wherein the presenting the number of users includes presenting the number of users in the first location and images associated with the users in the first location in response to the emergency notification.

9. The non-transitory computer-readable storage medium of claim 1, wherein the instructions are further configured to cause the computing system to:
maintain a status of the first access monitor and a status of the second access monitor,
wherein the presenting the determined location includes presenting the determined location of the user, the status of the first access monitor, and the status of the second access monitor.

10. The non-transitory computer-readable storage medium of claim 1, wherein the instructions are further configured to cause the computing system to maintain data associated with a deleted location.

11. The non-transitory computer-readable storage medium of claim 1, wherein the presenting the location of the user includes determining a presentation size for a mobile device.

12. A non-transitory computer-readable storage medium comprising instructions stored thereon that, when executed by at least one processor, are configured to cause a computing system to at least:
maintain locations and types of a plurality of access monitors;
retrieve estimated lifetimes of the plurality of access monitors based on the types of the plurality of access monitors;
determine when the plurality of access monitors are approaching an end of their estimated lifetimes; and
indicate locations of access monitors that are approaching the end of their estimated lifetimes.

13. The non-transitory computer-readable storage medium of claim 12, wherein the instructions are further configured to cause the computing system to:
receive a threshold from an administrator,
wherein the determining includes determining when the plurality of access monitors are approaching the end of their estimated lifetimes based in part on the received threshold.

14. The non-transitory computer-readable storage medium of claim 12, wherein:
the estimated lifetimes are time durations; and
the determining includes comparing an age of the access monitor to the time duration.

15. The non-transitory computer-readable storage medium of claim 12, wherein:
the estimated lifetimes are time durations; and
the determining includes comparing a time of first use of the access monitor to the time duration.

16. The non-transitory computer-readable storage medium of claim 12, wherein:
the estimated lifetimes are lifetime accesses to the access monitors; and
the determining includes:
maintaining a number of accesses to the access monitors; and
comparing the number of accesses to the access monitor to the lifetime accesses.

17. An electronic security system comprising:
a plurality of access monitors configured to send, in response to access requests from any of a plurality of users, access notifications to a computing system; and
the computing system configured to:
maintain locations and types of the plurality of access monitors;
retrieve estimated lifetimes of the plurality of access monitors based on the types of the plurality of access monitors;
receive the access notifications from the plurality of access monitors;
increment usage values associated with the plurality of access monitors in response to receiving the access notifications;
determine when the plurality of access monitors are approaching an end of their estimated lifetimes;
indicate locations of access monitors that are approaching the end of their estimated lifetimes;
update locations associated with the users based on the maintained locations of the plurality of access monitors and the received access notifications; and
present the updated locations.

18. The electronic security system of claim 17, wherein the computing system is further configured to generate reports with respect to locations of the access monitors, the reports including:
which users entered at least one of the locations;
when the users entered the at least one of the locations; and
how long the users were in the at least one of the locations.

19. The electronic security system of claim 17, wherein the computing system is further configured to present, in response to a notification of an emergency event:
a number of users that are in an endangered area;
identities of the users that are in the endangered area; and
images associated with the users that are in the endangered area.

20. The electronic security system of claim 17, wherein the computing system is further configured to maintain data associated with a deleted location.
